(19) United States
(12) Patent Application Publication
(10) Pub. No.: US 2016/0107302 A1
(43) Pub. Date: Apr. 21, 2016

(54) CHARGING SYSTEM FOR HYDRAULIC HAMMER

(71) Applicant: Caterpillar Inc., Peoria, IL (US)

(72) Inventors: Cody T. Moore, Waco, TX (US); Joshua Grzybowski, Waco, TX (US)

(73) Assignee: Caterpillar Inc., Peoria, IL (US)

(21) Appl. No.: 14/981,986

(22) Filed: Dec. 29, 2015

(51) Int. Cl. B25D 9/14; F15B 15/14; F15B 1/08

(52) U.S. Cl. CPC B25D 9/145; F15B 1/08; F15B 15/14; F15B 2201/205

(57) ABSTRACT

A charging system for a hydraulic hammer is disclosed. The charging system includes a charge plug. The charge plug is disposed on an opening defined in the wall housing connected to the top end of the power cell of a hammer. The charge plug is fluidly communicated to the chamber via a conduit. The charge plug includes a first compartment. The first compartment is configured to receive a first chemical substance. The charge plug also includes a second compartment. The second compartment is configured to receive a second chemical substance. The first compartment and the second compartment are covered by a membrane. A pressure difference causes collapsing of the membrane to allow the first chemical substance and the second chemical substance is allowed to react with each other. The reaction of the first chemical substance and the second chemical substance pressurizes the air within the chamber to a desired pressure.

### TECHNICAL FIELD

The present disclosure relates to a hydraulic hammer and more particularly relates to a charging system for the hydraulic hammer.

### BACKGROUND

Hydraulic hammers are used at work sites to break up large and hard objects before such objects can be moved away. Generally, hydraulic hammers are coupled to a machine, such as excavators or other machines. The hydraulic hammers are powered by a combination of hydraulic power and pneumatic power. The hydraulic hammers include a piston that is moved against a volume of nitrogen gas in a chamber coupled to a power cell of the hydraulic hammer. As the piston retracts, the volume of nitrogen gas in the chamber decreases and thereby increasing its pressure. The compressed nitrogen gas further facilitates downward movement of the piston. As such, the chamber needs to be charged by the nitrogen gas at a desired pressure. Conventionally, the chamber is charged by supplying a nitrogen gas from an external nitrogen tank before operation of the hydraulic hammer. However, the nitrogen gas may not be supplied to the chamber at the desire pressure and it is very difficult to charge the chamber using the external nitrogen tank.

US Patent Publication Number 2014/0209340 (the '340 application) discloses a hammer assembly including a hammer housing and a work tool movably supported in the hammer housing. A chamber is defined in the hammer housing and contains a compressible gas. An accumulator assembly includes an interior space. A barrier divides the interior space into a first interior portion containing a compressible gas and a second interior portion configured to receive a pressurized fluid. The barrier is configured to be movable in response to changing the amount of pressurized fluid in the second interior portion and such that movement of the barrier varies the volume of the first interior portion. The first interior portion is in communication with the chamber. However, in the '340 application, carrying a pressurized fluid source to supply the pressurized fluid to the second interior portion may lead to high operating cost. Further, it may be difficult to maintain a desired pressure of the compressible gas within the first interior portion.

### SUMMARY OF THE DISCLOSURE

In one aspect of the present disclosure, a charging system for a hydraulic hammer is disclosed. The hydraulic hammer includes a housing member and a power cell disposed within the housing member. The charging system includes wall housing. The wall housing is connected to the power cell such that it defines a chamber therein. A first end of a piston slidably disposed within the power cell is received within the chamber. A second end of the piston is configured to engage with a tool. The chamber is adapted to contain pressurized air for moving the piston between a first position and a second position. The charging system includes a charge plug. The charge plug is disposed on an opening define in the wall housing. The charge plug is fluidly communicated to the chamber via a conduit. The charge plug includes a first compartment. The first compartment is configured to receive a first chemical substance. The charge plug also includes a second compartment. The second compartment is disposed adjacent to the first compartment. The second compartment is configured to receive a second chemical substance. The first compartment and the second compartment are covered by a membrane. The piston moves from the first position to the second position during charging of the hydraulic hammer to create a pressure difference within the chamber. The pressure difference causes collapsing of the membrane to allow the first chemical substance and the second chemical substance react with each other. The reaction of the first chemical substance and the second chemical substance pressurizes the air within the chamber to a desired pressure.

Other features and aspects of this disclosure will be apparent from the following description and the accompanying drawings.

### BRIEF DESCRIPTION OF THE DRAWINGS

FIG. 1 is a side view of an exemplary machine having a hydraulic hammer, according to an embodiment of the present disclosure;

FIG. 2 is an exploded view of a power cell and a housing member of the hydraulic hammer of FIG. 1;

FIG. 3 is a perspective view of a portion of the power cell of FIG. 2 showing a charging system for the hydraulic hammer;

FIG. 4 is a sectional view of a portion of the power cell of FIG. 2 taken along line A-A′ of FIG. 3; and

FIG. 5 is a perspective view of a charge plug of the charging system of FIG. 3.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

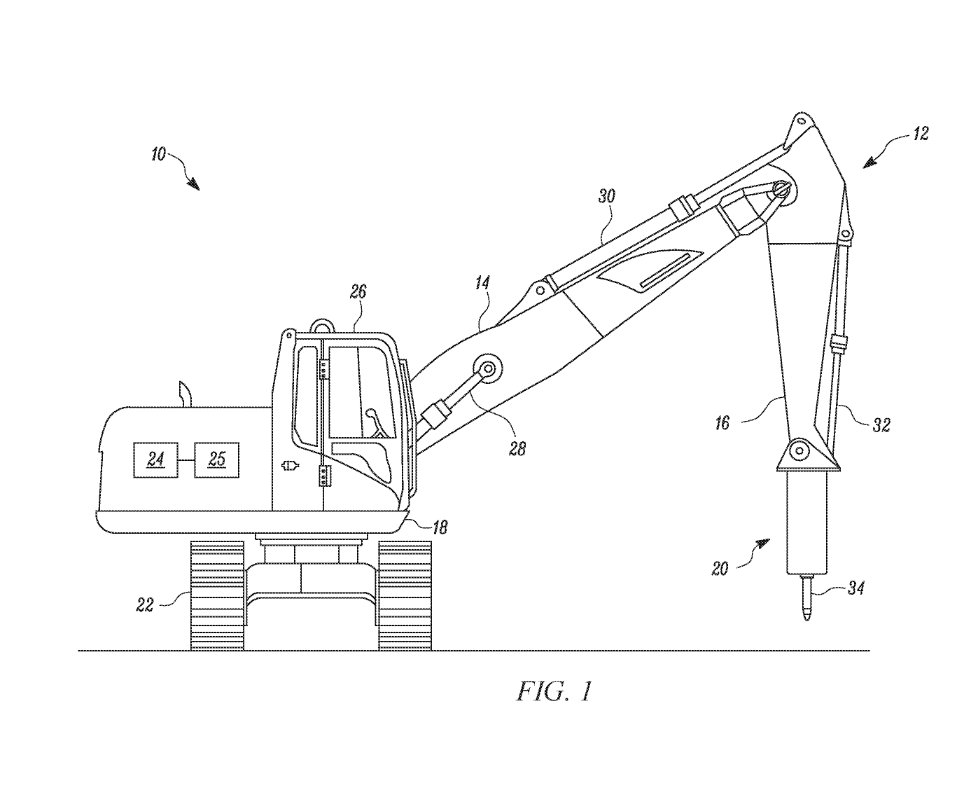

FIG. 1 illustrates a side view of an exemplary machine 10 having an implement system 12. The machine 10 may include, but is not limited to, an excavator, a material handler, a long reach excavator, a foundation drill, a rock drill, a piling machine, a tunneling machine, and a front shovel. In the illustrated embodiment, the machine 10 is shown as an excavator-type earthmoving machine having the implement system 12. The implement system 12 includes linkages, such as a boom 14 and a stick 16. The boom 14 is pivotally connected to a chassis 18 of the machine 10 and the stick 16 is pivotally connected to the boom 14.

The machine 10 further includes a hydraulic hammer 20 pivotally connected to the stick 16. The machine 10 includes a drive system 22, such as tracks for propelling the machine 10, a power source 24, such as an engine to power the implement system 12 and the drive system 22, and an operator cab 26 having user interface devices for controlling the implement system 12 and the drive system 22. The power source 24 may produce mechanical power output that may be converted to hydraulic power by a hydraulic system 25 for moving the implement system 12 and for operating the hydraulic hammer 20 during earth moving operation of the machine 10.

The boom 14 is raised and lowered by a first hydraulic actuator 28 and the stick 16 is moved toward and outward with respect to the boom 14 by a second hydraulic actuator 30. A third hydraulic actuator 32 is used to operate the hydraulic hammer 20 relative to the stick 16. Moreover, the chassis 18 is rotatable about a vertical-axis (not shown) with respect to the drive system 22. The hydraulic hammer 20 further includes a work tool 34 adapted to break rocks and penetrate through a work surface.

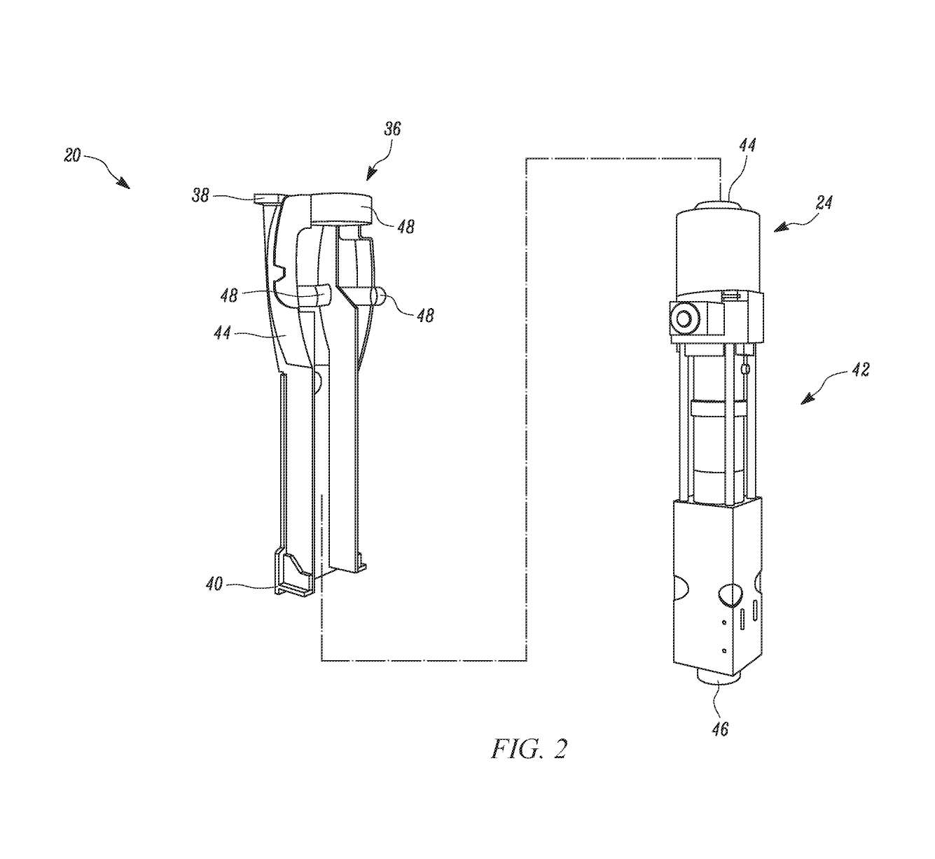

FIG. 2 illustrates an exploded view of the hydraulic hammer 20. The hydraulic hammer 20 includes a housing member 36. A cut sectional view of the housing member 36 is shown in FIG. 2. The housing member 36 includes a first end 38 and a second end 40. The first end 38 may be adapted to couple to the stick 16 of the implement system 12. The hydraulic hammer 20 further includes a power cell 42 having a top end 44 and a bottom end 46. The power cell 42 is received through the second end 40 of the housing member 36. The bottom end 46 of the power cell 42 is coupled to the work tool 34. More particularly, one end of the work tool 34 is received into the power cell 42 adjacent to the second end 40 and another end of the work tool 34 is adapted to engage with the work surface.

The power cell 42 is disposed within the housing member 36 with the help of a buffer system 48. The buffer system 48 may act as a vibration dampening mechanism between the power cell 42 and the housing member 36. In operation, the power cell 42 is subjected to impact loads due to contact of the work tool 34 with the work surface and hardness thereof. Such impact loads, if transferred to the hydraulic hammer 20, may cause wear of various components of the hydraulic hammer 20, particularly to the housing member 36 and the power cell 42.

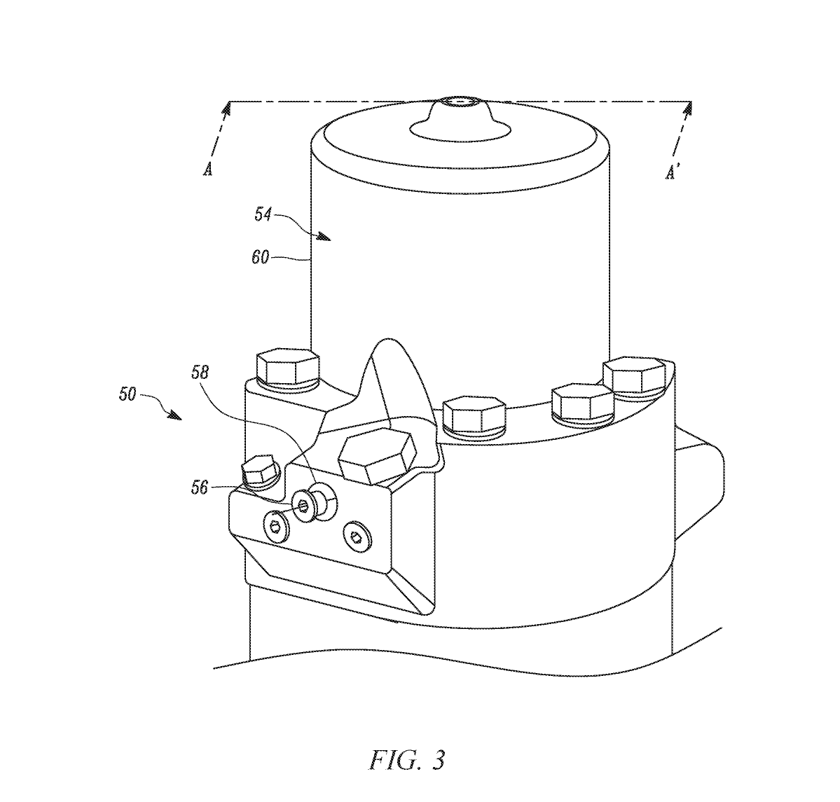

FIG. 3 illustrates a perspective view of a top portion of the hydraulic hammer 20 equipped with a charging system 50 for the hydraulic hammer 20. The charging system 50 is used to pre-charge the hydraulic hammer 20 before start of the operation thereof. The charging system 50 includes the power cell 42 and a wall housing 54 disposed adjacent to the top end 44 of the power cell 42. The charging system 50 further includes a charge plug 56 disposed within an opening 58 defined in the wall housing 54. The charge plug 56 is adapted to charge the hydraulic hammer 20 before start of the operation of the hydraulic hammer 20.

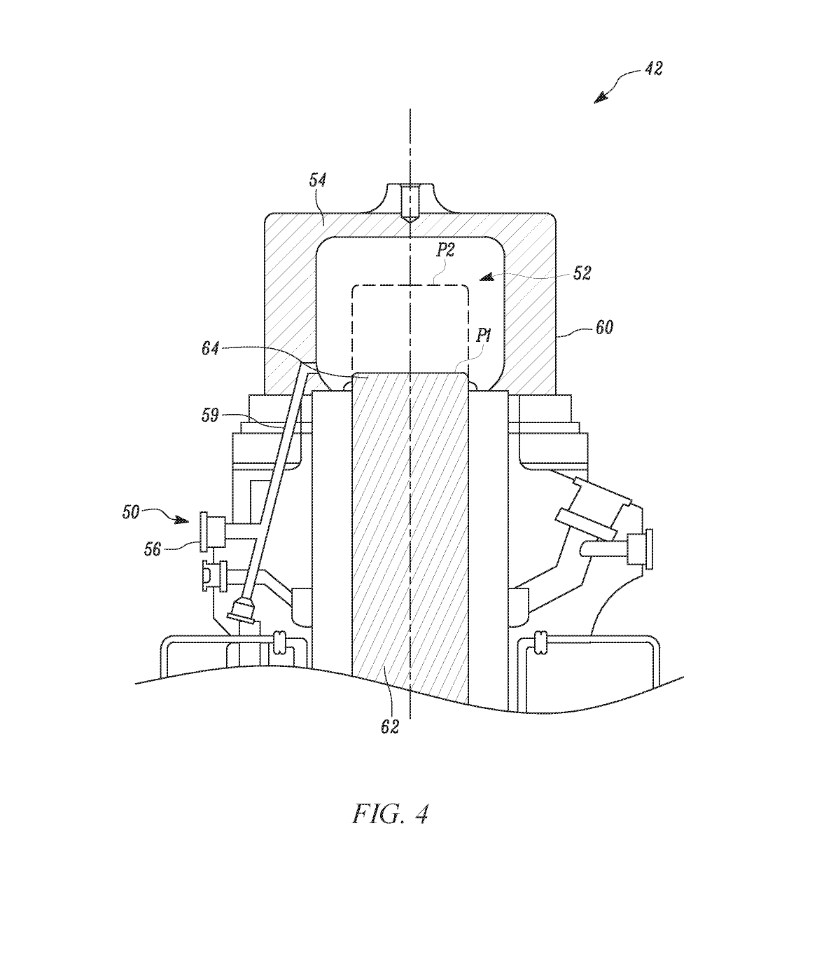

FIG. 4 illustrates a sectional view of a portion of the power cell 42 of the hydraulic hammer 20 taken along line A-A′ of FIG. 3. The power cell 42 includes a case 60 adapted to slidably receive a piston 62. The wall housing 54 is coupled to the case 60 adjacent to the top end 44 of the power cell 42. The wall housing 54 defines a chamber 52. The chamber 52 may define a volume which may be varied based on an upward and a downward movement of the piston 62. The downward movement of the piston 62 may correspond to a movement of the piston 62 towards a first position ‘P1’ and the upward movement of the piston 62 may correspond to a movement of the piston 62 towards a second position ‘P2’ thereof.

The chamber 52 is charged with pressurized air at a desired pressure by the charging system 50 before start of the operation of the hydraulic hammer 20. The charge plug 56 fluidly communicates with the chamber 52 via a conduit 59. The piston 62 has a first end 64 and a second end (not shown) adapted to contact with the work tool 34. The piston 62 is further actuated by the hydraulic system 25 of the machine 10 for operation of the hydraulic hammer 20. The wall housing 54 defines the chamber 52 therein proximal to the first end 64 of the piston 62. During the upward movement of the piston 62, the first end 64 of the piston 62 is received within the chamber 52 and during the downward movement of the piston 62, the first end 64 moves out from the chamber 52. The chamber 52 and the piston 62 are arranged in a manner, such that the volume of the chamber 52 increases when the piston 62 moves downward and decreases when the piston 62 moves upward. Decrease in the volume of the chamber 52 may increase pressure of air within the chamber 52. In an example, such increase in pressure of the air within the chamber 52 may facilitate downward movement of the piston 62 during the operation of the hydraulic hammer 20. Thus, the chamber 52 is adapted to contain a pressurized air therein for moving the piston 62 between the first position ‘P1’ and the second position ‘P2’ during the operation of the hydraulic hammer 20.

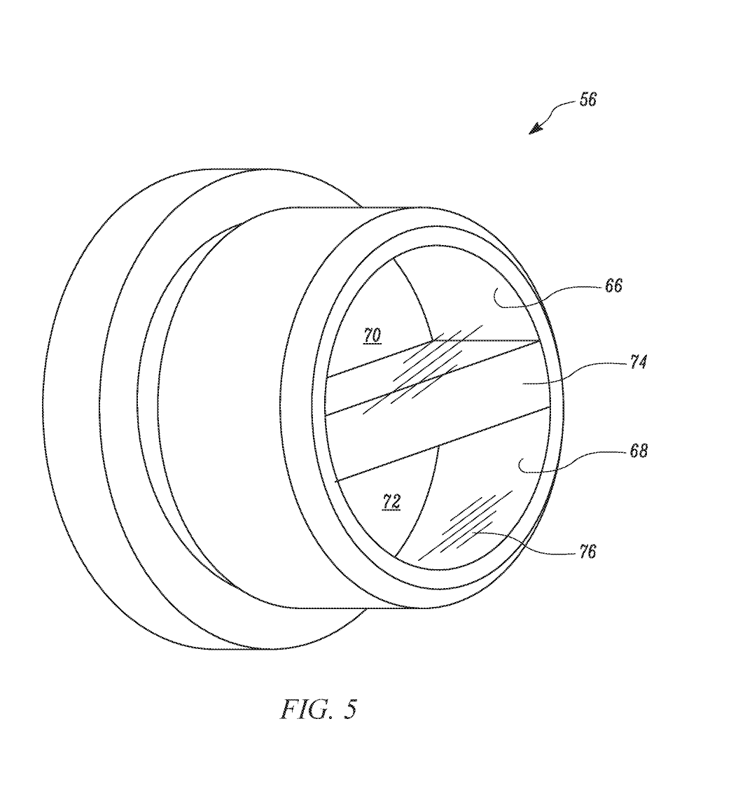

FIG. 5 illustrates a perspective view of the charge plug 56 of the charging system 50. The charge plug 56 include a first compartment 66 and a second compartment 68 disposed adjacent to the first compartment 66. Although two compartments are illustrated in FIG. 5, it will be understood that the charge plug 56 may include more than two compartments, without departing from the scope of the disclosure. The first compartment 66 is adapted to receive a first chemical substance 70. The second compartment 68 is adapted to receive a second chemical substance 72. In an example, the first chemical substance 70 and the second chemical substance 72 are selected such that chemical reaction between the first and second chemical substances 70, 72 generates a gas that gets added to the air present in the chamber 52, thereby causing increase in pressure of the air to a desired pressure. An amount of the first chemical substance 70 in the first compartment 66 and the second chemical substance 72 in the second compartment 68 depends on various parameters including, but not limited to, type of chemicals substances used in the respective compartments and the predefined pressure of the gas to be produced during reaction between the first and second chemical substances 70, 72.

The charge plug 56 includes a separating member 74 separating the first compartment 66 and the second compartment 68. The charge plug 56 further includes a membrane 76 attached to a periphery of the charge plug 56. The membrane 76 is adapted to cover the first compartment 66 and the second compartment 68 of the charge plug 56. Person skilled in the art will understand that the membranes may be selected based on various parameters including, but not limited to, the type of the first chemical substance 70 and the second chemical substance 72 and tear resistance properties of the membrane 76. In an example, the membrane 76 is chemically non reactive. The membrane 76 is adapted to collapse due to a pressure difference developed within the chamber 52 (shown in FIG. 4) due to the movement of the piston 62 between the first position ‘P1’ and the second position ‘P2’ thereof. The charge plug 56 may further include a pin (not shown). The pin may be used as an actuating device between the first compartment 66 and the second compartment 68.

The piston 62 moves from the first position ‘P1’ to the second position ‘P2’ during charging of the hydraulic hammer 20 to create the pressure difference within the chamber 52. The pressure difference causes collapsing of the membrane 76 to allow the first chemical substance 70 and the second chemical substance 72 to react with each other. The reaction of the first chemical substance 70 and the second chemical substance 72 produces the gas at the predefined pressure. The gas further pressurizes the air within the chamber 52 to the desired pressure. The predefined pressure of the gas causes charging of the chamber 52 with the air at the desired pressure.

### INDUSTRIAL APPLICABILITY

The charging system 50 described herein may be implemented in hydraulic hammers of any size or configuration having the chamber 52 for providing at least some of impact energy for the hydraulic hammer 20. For example, the charging system 50 may be implemented in a manner, such that requirement of an external nitrogen tank to charge the hydraulic hammer 20 may be avoided. This may allow the hydraulic hammer 20 to be used in a more versatile manner. For instance, the charging system 50 may be used to pressurize the atmospheric air enclosed in the chamber 52 more quickly than that of conventional methods and also may ease the tedious process of charging the hydraulic hammer 20 by eliminating usage of external tanks used in conventional methods.

During charging of the hydraulic hammer 20, the piston 62 internal to the hydraulic hammer 20 is made to move such that the pressure difference in the chamber 52 of the hydraulic hammer 20 causes collapsing of the membrane 76 located on the periphery of the charge plug 56 of the charging system 50. As the membrane 76 collapses, the first chemical substance 70 present in the first compartment 66 and the second chemical substance 72 present in the second compartment 68 purge out from the first and second compartments 66, 68 respectively. The first chemical substance 70 and the second chemical substance 72 chemically react to produce the gas. The gas flows through the conduit 59 into the chamber 52 thereby, pressurizing the air present in the chamber 52. The compressed air in the chamber 52 facilitates the upward and the downward movement of the piston 62 for the working of the hydraulic hammer 20 of the machine 10.

Owing to the presence of the charge plug 56 which accommodates the first chemical substance 70 in the first compartment 66 and the second chemical substance 72 in the second compartment 68, the requirement of a device to supply additional chemical substance into the chamber 52 is overcome. As such, cost of the charging the chamber 52 is minimized, which was otherwise higher due to the requirement of an external aid. In other words, the first chemical substance 70 and the second chemical substance 72 reacts to generate the gas that adds to the volume of air present in the chamber 52, thereby causing increase in pressure of the air to the desired pressure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A charging system for a hydraulic hammer, the hydraulic hammer comprising a housing member and a power cell disposed within the housing member, the charging system comprising:
a wall housing connected to a top end of the power cell, and defining a chamber therein, wherein a first end of a piston slidably disposed within the power cell is received within the chamber and a second end is configured to engage with a tool, and wherein the chamber is adapted to contain pressurized air for moving the piston between a first position and a second position; and
a charge plug disposed on an opening defined in the wall housing, the charge plug is fluidly communicated to the chamber via a conduit, the charge plug including:
a first compartment configured to receive a first chemical substance; and
a second compartment disposed adjacent to the first compartment, the second compartment configured to receive a second chemical substance, wherein each of the first compartment and the second compartment is covered by a membrane,
wherein the piston moves from the first position to the second position during charging of the hydraulic hammer to create a pressure difference within the chamber, and wherein the pressure difference causes collapsing of the membrane to allow the first chemical substance and the second chemical substance react with each other, and wherein reaction of the first chemical substance and the second chemical substance pressurizes the air within the chamber to a desired pressure.
